(19) United States
(12) Patent Application Publication
(10) Pub. No.: US 2013/0135894 A1
(43) Pub. Date: May 30, 2013

(54) BACKLIGHT MODULE

(71) Applicant: Qisda Corporation, Taoyuan Shien (TW)

(72) Inventors: Yi-Cheng Kuo, Taoyuan County (TW); Cheng-Wen Hsu, Taoyuan County (TW)

(73) Assignee: QISDA CORPORATION, Taoyuan Shien (TW)

(21) Appl. No.: 13/655,504

(22) Filed: Oct. 19, 2012

(30) Foreign Application Priority Data
Oct. 20, 2011 (TW) 100138119

(51) Int. Cl. F21V 8/00

(52) U.S. Cl. CPC G02B 6/0068
USPC 362/606; 362/613

(57) ABSTRACT

A backlight module comprising a light guide plate and a light source is provided. The light guide plate has a light-out surface, which defines a first light-out region and a second light-out region. The light guide plate comprises a V-shaped light guide structure corresponding to the first light-out region. The light source is disposed corresponding to the V-shaped light guide structure and has a light-out surface, which faces a direction parallel to an extension direction of a long axial of V-shaped light guide structure. When the light source emits a light, the V-shaped light guide structure guides the light to illuminate the first light-out region, and the second light-out region may be not influenced by the light of the light source.

This application claims the benefit of Taiwan application Serial No. 100138119, filed Oct. 20, 2011, the subject matter of which is incorporated herein by reference.

### BACKGROUND OF THE INVENTION

1. Field of the Invention

The invention relates in general to a backlight module, and more particularly to a backlight module capable of centralizing an outgoing light.

2. Description of the Related Art

The conventional backlight module comprises a light guide plate and a light source. The light source, such as an LED light source, emits a light to the light guide plate. The light entering to the light guide plate is guided to the light-out surface and then projected on the display panel.

In general, the range of the light emitting angle of the out-going light of the light source is approximately a fan shape of 120 degrees, such that the light correspondingly forms a fan shape of 120 degrees from the light-out region of the light guide plate. The light in the middle portion of the light emitting angle has the largest intensity, and the light in the two edges of the light emitting angle has the smallest intensity. The dispersive distribution of the light intensity makes the display quality deteriorated and the light intensity at the two edges of the fan shape hard to control.

### SUMMARY OF THE INVENTION

The invention is directed to a backlight module capable of centralizing and emitting an outgoing light of the light guide plate.

According to an embodiment of the present invention, a backlight module is provided. The backlight module comprises a light guide plate, a first light source and a second light source. The light guide plate has a light-out surface, which defines a first light-out region and a second light-out region. The light guide plate comprises a first protrusion portion and a second protrusion portion, wherein the position of the first protrusion portion corresponds to the first light-out region, and the position of the second protrusion portion corresponds to the second light-out region. The first light source is disposed corresponding to the first protrusion portion and has a first light-out surface, which faces a direction parallel to an extension direction of a long axial of the first protrusion portion. The second light source is disposed corresponding to the second protrusion portion and has a second light-out surface, which faces a direction parallel to an extension direction of a long axial of the second protrusion portion. The first protrusion portion guides the light of the first light source substantially to the first light-out region, and the second protrusion portion guides the light of the second light source substantially to the second light-out region.

According to another embodiment of the present invention, a backlight module is provided. The backlight module comprises a light guide plate and a light source. The light guide plate has a light-out surface, which defines a first light-out region and a second light-out region. The light guide plate comprises a V-shaped light guide structure corresponding to the first light-out region. The light source is disposed corresponding to the V-shaped light guide structure and has a light-out surface, which faces a direction parallel to an extension direction of a long axial of V-shaped light guide structure. When the light source emits a light, the V-shaped light guide structure guides the light to illuminate the first light-out region, and the second light-out region may be not influenced by the light of the light source.

According to an alternate embodiment of the present invention, a backlight module is provided. The backlight module comprises a light guide plate and a light source. The light guide plate has a light-out surface and a light-entering lateral surface, the light-out surface defines a first light-out region and a second light-out region adjacent to the first light-out region. The light guide plate comprises a first refraction surface, which corresponds to the first light-out region. The light source is disposed corresponding to the light-entering lateral surface and has a first light-out surface, which faces a direction parallel to an extension direction of the first refraction surface. When the light source emits a light, the light emitted by the light source passes through the first refraction surface along a first direction and then proceeds along a second direction, wherein the first direction is directed towards the second light-out region, and the second direction is directed towards the first light-out region.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 shows a top view of a backlight module according to an embodiment of the invention;

FIG. 2 shows a cross-sectional view along a direction 2-2′ of FIG. 1;

FIG. 3 shows a cross-sectional view of a light guide plate of a backlight module according to another embodiment of the invention;

FIG. 4 shows a cross-sectional view of a light guide plate of a backlight module according to another embodiment of the invention;

FIG. 5A shows a partial top view of a backlight module according to another embodiment of the invention;

FIG. 5B shows a cross-sectional view along a direction 5B-5B′ of FIG. 5A;

FIG. 6 shows a cross-sectional view of a light guide plate of a backlight module according to another embodiment of the invention;

FIG. 7 shows a top view of a backlight module according to another embodiment of the invention.

### DETAILED DESCRIPTION OF THE INVENTION

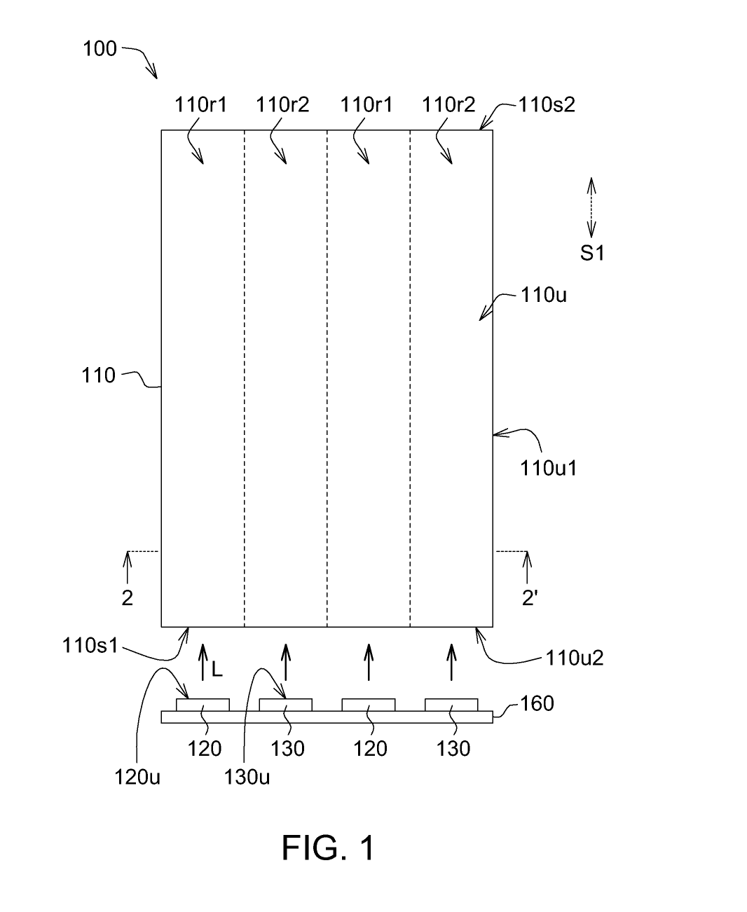

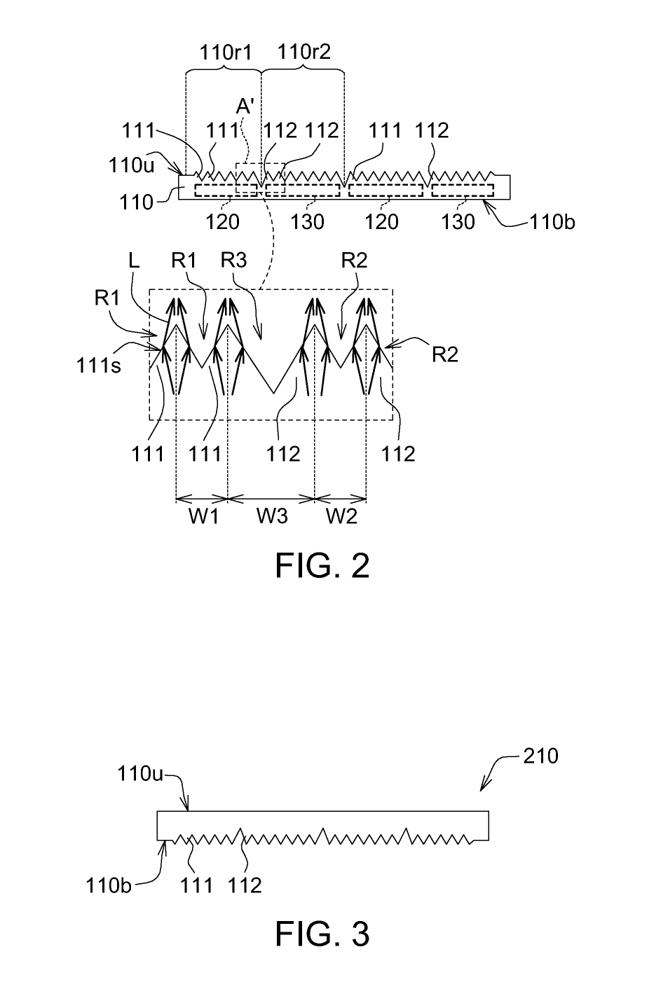

Referring to FIGS. 1 and 2. FIG. 1 shows a top view of a backlight module according to an embodiment of the invention. FIG. 2 shows a cross-sectional view along a direction 2-2′ of FIG. 1.

As indicated in FIG. 1, the backlight module 100 comprises a light guide plate 110, several first light sources 120 and several second light sources 130.

The light guide plate 110 has a light-out surface 110u, which defines several first light-out regions 110r1 and several second light-out regions 110r2. In another embodiment, the light-out surface 110u of the light guide plate 110 may only define one first light-out region 110r1 and one second light-out region 110r2. In the present embodiment, the first light-out region 110r1 and the second light-out region 110r2 both are a strip-shaped light-out region, wherein the first light-out region 110r1 is substantially parallel to the second light-out region 110r2, but the invention is not limited thereto.

The light-out surface 110u has a long side 110u1 and a short side 110u2 adjacent thereto, wherein the long side 110u1 and the short side 110u2 define the boundaries of the light-out surface 110u. The light guide plate 110 has a light-entering lateral surface 110s1 and a lateral surface 110s2 opposite to the light-entering lateral surface 110s1. The short side 110u2 of the light-out surface 110u is extended between the light-entering lateral surface 110s1 and the opposite lateral surface 110s2.

As indicated in FIG. 2, the light guide plate 110 comprises several first protrusion portions 111 and several second protrusion portions 112. The light guide plate 110 further has a bottom surface 110b opposite to the light-out surface 110u. The first protrusion portion 111 and the second protrusion portion 112 are formed on one of the bottom surface 110b and the light-out surface 110u. In the present embodiment, the first protrusion portion 111 and the second protrusion portion 112 are formed on the light-out surface 110u. In another embodiment, the quantity of the first protrusion portion 111 and that of the second protrusion portion 112 are respectively one. The invention does not specify the quantity of the first protrusion portion 111 and that of the second protrusion portion 112.

In the present embodiment, the position of the first protrusion portions 111 corresponds to the first light-out region 110r1, and the position of the second protrusion portions 112 corresponds to the second light-out region 110r2. In another embodiment, the position of one first protrusion portion 111 may correspond to the first light-out region 110r1 and/or the position of one second protrusion portion 112 may correspond to the second light-out region 110r2.

The first protrusion portion 111 and the second protrusion portion 112 are extended between the light-entering lateral surface 110s1 and the opposite lateral surface 110s2. In the present embodiment, the first protrusion portion 111 and the second protrusion portion 112 are extended from the light-entering lateral surface 110s1 to the opposite lateral surface 110s2 (As indicated in FIG. 1). That is, the first protrusion portion 111 and the second protrusion portion 112 are substantially parallel to the long side 110u1. Moreover, the first protrusion portion 111 and the second protrusion portion 112 may be extended to a length substantially equal to the length of the long side 110u1. In another embodiment, the first protrusion portion 111 and the second protrusion portion 112 are not extended to the light-entering lateral surface 110s1 and the opposite lateral surface 110s2 but are separated from at least one of the light-entering lateral surface 110s1 and the opposite lateral surface 110s2 by a distance. In other embodiment, the first protrusion portion 111 and the second protrusion portion 112 are also substantially parallel to the short side 110u2, In the present embodiment, the first protrusion portion 111 and the second protrusion portion 112 may be extended to a length shorter than or substantially equal to the length of the short side 110u2.

As indicated in a partial enlargement of a portion A′ of FIG. 2, the first protrusion portion 111 and the second protrusion portion 112 both are a V-shaped light guide structure. Let the first protrusion portion 111 be taken for example. The lateral surface 111s of the first protrusion portion 111 may be realized as a plane. In another embodiment, the lateral surface 111s of the first protrusion portion 111 may also be realized as a curvature, such as a concave curvature or a convex curvature, wherein the convex curvature has such as a circular shape or an elliptical shape. Or, the lateral surface 111s of the first protrusion portion 111 may comprise several segmental surfaces (at least one of curvature and plane), wherein two adjacent segmental surfaces are interconnected. The cross-sectional shape of the first protrusion portion 111 is such as a polygon, a circle or an ellipse, wherein the polygon such as a triangle (that is, the V-shaped protrusion portion), a trapezoid or a quadrilateral. Furthermore, any structures capable of generating the light concentrating effect as indicated in a partial enlargement of a portion A′ of FIG. 2 can be applied to the first protrusion portion 111. In addition, at least two cross-sectional shapes of the first protrusion portions 111 may be the same or different. The structure of the second protrusion portion 112 is similar to that of the first protrusion portion 111, and the similarities are not repeated here.

As indicated in a partial enlargement of a portion A′ of FIG. 2, a first groove R1 is formed between two adjacent first protrusion portions 111, and a second groove R2 is formed between two adjacent second protrusion portions 112. The depths of at least two of the first grooves R1 may substantially be the same or different, and the widths of at least two of the first grooves R1 may substantially be the same or different. Likewise, the depths of at least two of the second grooves R2 may substantially be the same or different, and the widths of at least two of the second grooves R2 may substantially be the same or different. Additionally, the distances between the recess bottoms of the first grooves R1 and the bottom surface 110b of the light guide plate 110 may be the equal or different. Likewise, the distances between the recess bottoms of the second grooves R2 and the bottom surface 110b of the light guide plate 110 may be the equal or different.

As indicated in a partial enlargement of a portion A′ of FIG. 2, a third groove R3 is formed between the first protrusion portion 111 and the second protrusion portion 112 adjacent thereto. The position of the third groove R3 is close to the first light-out region 110r1 or the second light-out region 110r2. For example, the position of the third groove R3 is close to the juncture between the first light-out region 110r1 and the second light-out region 110r2. That is, the third groove R3 is closer to the juncture between the first light-out region 110r1 and the second light-out region 110r2 than the first groove R1 and the second groove R2.

As indicated in FIG. 2, in the present embodiment, the width W3 of the third groove R3 is larger than the width W1 of the first groove R1 and the width W2 of the second groove R2. For example, the third groove R3 is a wider V-shaped groove, and the first groove R1 and the second groove R2 both are a narrower V-shaped groove. Thus, the out-going light of one of the light-out regions (such as the out-going light of one of the first protrusion portion 111 and the second protrusion portion 112) is prevented from entering the other light-out region (such as enters to the other one of the first protrusion portion 111 and the second protrusion portion 112) via the third groove R3, so that the light separation effect between two adjacent light-out regions is more significant. In another embodiment, the width W3 of the third groove R3 may be smaller than or substantially equal to the width W1 of the first groove R1 and/or the width W2 of the second groove R2. In addition, the depth of the third groove R3 may be smaller than or substantially equal to the depth of the first groove R1 and/or the depth of the second groove R2.

As indicated in FIGS. 1 and 2, the first light source 120 is disposed corresponding to the first protrusion portion 111 and has a first light-out surface 120u. The first light-out surface 120u faces a direction parallel to an extension direction of a long axial of S1 of the first protrusion portion 111. In the present embodiment, one first light source 120 is disposed corresponding to one first light-out region 110r1. In another embodiment, several first light sources 120 may be disposed corresponding to one first light-out region 110r1. In addition, the first light source 120 is realized by such as light emitting diodes.

As indicated in FIGS. 1 and 2, the second light source 130 is disposed corresponding to the second protrusion portion 112 and has a second light-out surface 130u. The second light-out surface 130u faces a direction parallel to an extension direction of a long axial of S1 of the second protrusion portion 112. In the present embodiment, one second light source 130 is disposed corresponding to one second light-out region 110r2. In another embodiment, several second light sources 130 may be disposed corresponding to the one second light-out region 110r2. In addition, the second light source 130 is realized by such as light emitting diodes.

The first light source 120 and the second light source 130 are disposed corresponding to the short side 110u2 of the light-out surface 110u. In the first light source 120, the first light-out surface 120u faces the light-entering lateral surface 110s1, and in the second light source 130, the second light-out surface 130u faces the light-entering lateral surface 110s1.

In the present embodiment, the portion between the first light source 120 and the second light source 130 may correspond to the portion (such as the third groove R3) between the first protrusion portion 111 and the second protrusion portion 112, but the invention is not limited thereto.

In addition, the backlight module 100 further comprises a first light guide rod 160, which comprises a first light source 120 and a second light source 130. The first light guide rod 160 is disposed corresponding to the long side 110u1. The first light guide rod 160 further comprises a circuit board (not illustrated) electrically connected to the first light source 120 and the second light source 130 for controlling the intensity of the light emitted to the light guide plate 110 by the first light source 120 and the second light source 130 respectively.

As indicated in FIGS. 1 and 2, since the first light-out surface 120u faces a direction parallel to an extension direction of a long axial S1 of the first protrusion portion 111 and the second light-out surface 130u faces a direction parallel to an extension direction of a long axial S1 of the second protrusion portion 112, the first protrusion portion 111 may guide the light L of the first light source 120 (FIG. 2) substantially to the first light-out region 110r1, and the second protrusion portion 112 may guide of the light L of the second light source 130 (FIG. 2) substantially to the second light-out region 110r2. Thus, the second light-out region 110r2, substantially not influenced by the light of the first light source 120, may easily control the intensity of the out-going light of the light guide plate. That is, the light L of the first light source 120 is guided by the first protrusion portion 111 to be centralized and then emitted to the first light-out region 110r1 of the light guide plate 110, and the light L of the second light source 130 is guided by the second protrusion portion 112 to be centralized and then emitted to the second light-out region 110r2 of the light guide plate 110.

Referring to FIG. 3, a cross-sectional view of a light guide plate of a backlight module according to another embodiment of the invention is shown. The other first protrusion portion 111 and the other second protrusion portion 112 may be formed on the bottom surface 110b of the light guide plate 210.

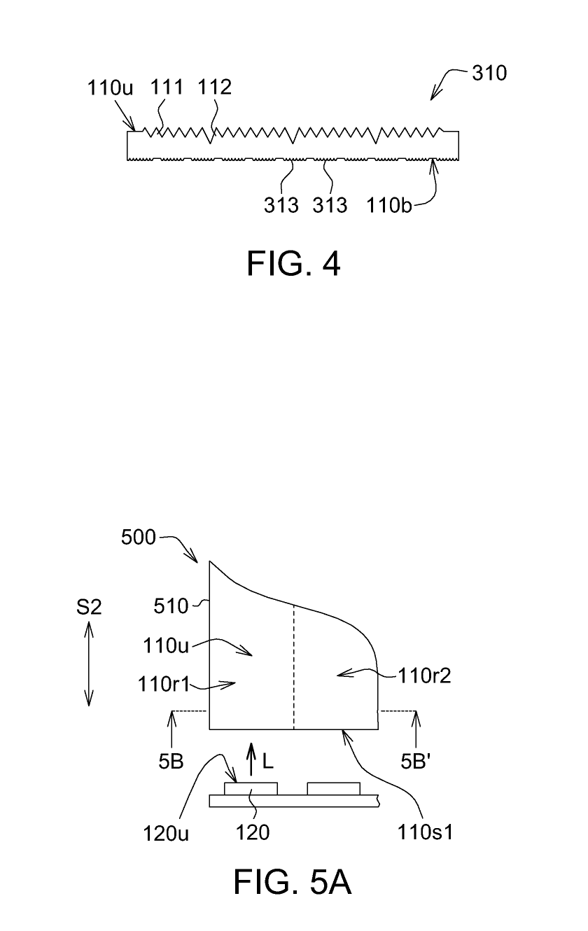

Referring to FIG. 4, a cross-sectional view of a light guide plate of a backlight module according to another embodiment of the invention is shown. The light guide plate 310 further comprises at least one the light expansion structure 313 formed on the bottom surface 110b of the light guide plate 110.

The light expansion structure 313 such as a dot structure. The light entering the light expansion structure 313 may be diffused or scattered to the light-out surface 110u of the light guide plate 110.

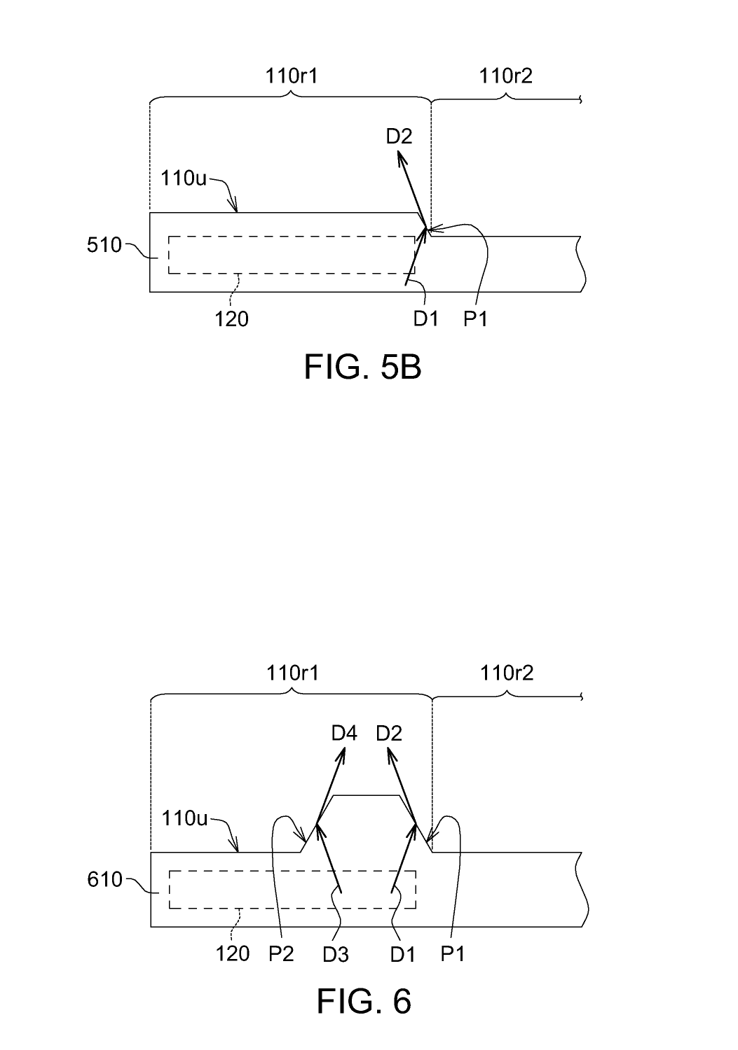

Referring to FIG. 5A, a partial top view of a backlight module according to another embodiment of the invention is shown. The backlight module 500 comprises a light guide plate 510 and a light source 120. The light guide plate 510 has a light-out surface 110u and a light-entering lateral surface 110s1. The light-out surface 110u of the light guide plate 510 defines a first light-out region 110r1 and a second light-out region 110r2 adjacent thereto. The first light-out region 110r1 and the second light-out region 110r2 are extended along an extension direction S2. The light source 120 is disposed corresponding to the light-entering lateral surface 110s1 and has a first light-out surface 120u.

Referring to FIG. 5B, a cross-sectional view along a direction 5B-5B′ of FIG. 5A is shown. The light guide plate 510 comprises at least one first refraction surface P1, which corresponds to the first light-out region 110r1. In the light source 120, the first light-out surface 120u (illustrated in FIG. 5A) faces a direction parallel to an extension direction S2 of the first refraction surface P1 (illustrated in FIG. 5A).

As indicated in FIG. 5B, when the light source 120 emits a light, the light L emitted by the light source 120 along a first direction D1 passes through the first refraction surface P1 and then proceeds along a second direction D2, wherein, the first direction D1 is directed towards the second light-out region 1102, and the second direction D2 is directed towards the first light-out region 110r1. Furthermore, the light L passing through the first refraction surface P1 is centralized towards the first light-out region 110r1. Moreover, the silhouette of the first refraction surface P1 may be similar to the lateral surface 111s of the first protrusion portion 111, and the similarities are not repeated here.

Referring to FIG. 6, a cross-sectional view of a light guide plate of a backlight module according to another embodiment of the invention is shown. In comparison to the light guide plate 510, the light guide plate 610 further has at least one second refraction surface P2 which corresponds to the first light-out region 110r1. The first light-out surface P1 (illustrated in FIG. 5A) of the light source 120 faces a direction parallel to an extension direction S2 (illustrated in FIG. 5A) of the second refraction surface P2.

When the light source 120 emits a light, the light L emitted by the light source 120 along a third direction D3 passes through the second refraction surface P2 and then proceeds along a fourth direction D4, wherein, the third direction D3 is directed away from the second light-out region 110r2, and the fourth direction D4 is directed towards the first light-out region 110r1. Furthermore, the light L passing through the first refraction surface P1 and the second refraction surface P2 is centralized towards the first light-out region 110r1. In addition, the silhouette of the second refraction surface P2 may be similar to the first refraction surface P1, and the similarities are not repeated here.

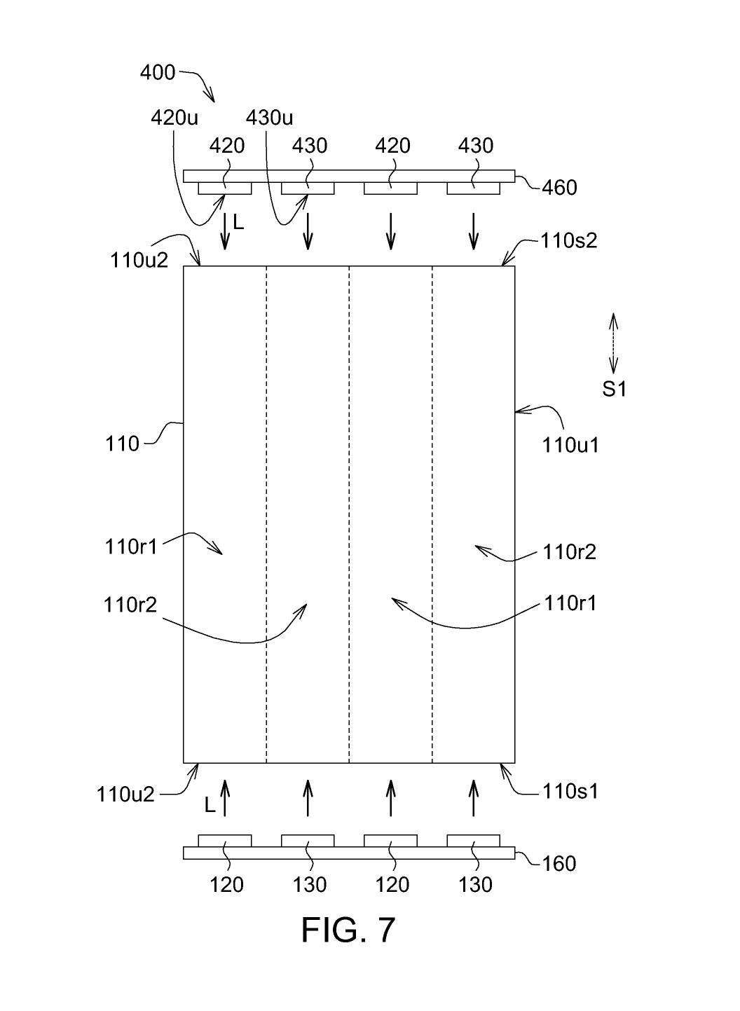

Referring to FIG. 7, a top view of a backlight module according to another embodiment of the invention is shown. The backlight module 400 comprises a light guide plate 110, several first light sources 120, several second light source 130, several third light source 420 and several fourth light source 430.

The third light source 420 and the fourth light source 430 are disposed corresponding to a short side 110u2 of the light guide plate 110. The third light source 420 has a third light-out surface 420u which faces the opposite lateral surface 110s2. The fourth light source 430 has a fourth light-out surface 430u, which faces the opposite lateral surface 110s2. Due to the first light source 120, the second light source 130, the third light source 420 and the fourth light source 430, the intensity and uniformity of the outgoing light of the backlight module 400 are thus increased.

In addition, the backlight module 100 further comprises a second light guide rod 460, which comprises a third light source 420 and a fourth light source 430. The second light guide rod 460 is disposed corresponding to the short side 110u2.

The second light guide rod 460 further comprises a circuit board (not illustrated) electrically connected to the third light source 420 and the fourth light source 430 for controlling the third light source 420 and the fourth light source 430 to respectively or synchronically emit a light to the opposite lateral surface 110s2 of the light guide plate 110. In the present embodiment, the opposite lateral surface 110s2 is a light-entering lateral surface.

The backlight modules 100, 400 and 500 disclosed in the above embodiments may be used in a display panel to form a display device with the display panel. Examples of the display panel include liquid crystal display panel and organic light-emitting diode (OLED) display.

According to the backlight module disclosed in the above embodiments of the invention, the first light-out surface faces a direction parallel to an extension direction of a long axial of the first protrusion portion and the second light-out surface faces a direction parallel to an extension direction of a long axial of the second protrusion portion, so that the first protrusion portion may guide the light emitted by the first light source substantially to the first light-out region, and the second protrusion portion may guide the light emitted by the second light source substantially to the second light-out region. Thus, the second light-out region is not influenced by the light of the first light source, and the intensity of the out-going light of the light guide plate may be easily controlled.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A backlight module, comprising:
a light guide plate having a light-out surface, which defines a first light-out region and a second light-out region, wherein the light guide plate comprises a first protrusion portion and a second protrusion portion, the position of the first protrusion portion corresponds to the first light-out region, and the position of the second protrusion portion corresponds to the second light-out region;
a first light source disposed corresponding to the first protrusion portion, wherein the first light source has a first light-out surface which faces a direction parallel to an extension direction of a long axial of the first protrusion portion; and
a second light source disposed corresponding to the second protrusion portion, wherein the second light source has a second light-out surface, which faces a direction parallel to an extension direction of a long axial of the second protrusion portion;
wherein, the first protrusion portion guides a outgoing light of the first light source substantially to the first light-out region, and the second protrusion portion guides a outgoing light of the second light source substantially to the second light-out region.

2. The backlight module according to claim 1, wherein the first light-out region and the second light-out region both are a strip-shaped light-out region, and the first light-out region is substantially parallel to the second light-out region.

3. The backlight module according to claim 1, wherein the light-out surface has a long side and a short side adjacent thereto, the light guide plate has a light-entering lateral surface, the first light source and the second light source are disposed corresponding to the short side of the light-out surface, and the first light-out surface and the second light-out surface face the light-entering lateral surface.

4. The backlight module according to claim 1, wherein the light guide plate has a light-entering lateral surface and an opposite lateral surface opposite to the light-entering lateral surface, the first protrusion portion and the second protrusion portion are extended to the opposite lateral surface from the light-entering lateral surface;
the backlight module further comprises:
a third light source having a third light-out surface, which faces the opposite lateral surface; and
a fourth light source having a fourth light-out surface, which faces the opposite lateral surface.

5. The backlight module according to claim 1, wherein the first protrusion portion and the second protrusion portion both are a V-shaped light guide structure.

6. The backlight module according to claim 1, wherein the light guide plate further has a bottom surface opposite to the light-out surface, the first protrusion portion and the second protrusion portion are formed on one of the bottom surface and the light-out surface.

7. The backlight module according to claim 1, wherein the light guide plate further has a bottom surface opposite to the light-out surface, the first protrusion portion and the second protrusion portion are formed on one of the light-out surface and the bottom surface, and the light guide plate further comprises:
a light expansion structure formed on the other one of the light-out surface and the bottom surface.

8. The backlight module according to claim 1, wherein the light guide plate comprises:
a plurality of first protrusion portions, wherein a first groove is formed between two adjacent first protrusion portions; and
a plurality of second protrusion portion, wherein a second groove is formed between two adjacent second protrusion portions;
wherein, a third groove is formed between the first protrusion portion and the second protrusion portion adjacent thereto, and a width of the third groove is larger than a width of the first groove and a width of the second groove.

9. A backlight module, comprising:
a light guide plate having a light-out surface, which defines a first light-out region and a second light-out region, wherein the light guide plate comprises a V-shaped light guide structure corresponding to the first light-out region;
a first light source disposed corresponding to the V-shaped light guide structure, wherein the first light source has a first light-out surface, which faces a direction parallel to an extension direction of a long axial of the V-shaped light guide structure;
wherein, when the first light source emits a light, the V-shaped light guide structure guides the light of the first light source to illuminate the first light-out region, and the second light-out region substantially is not influenced by the light of the first light source.

10. The backlight module according to claim 9, wherein the light-out surface has a long side and a short side adjacent thereto, the first light source is disposed corresponding to the short side of the light-out surface, and the light guide plate comprises:
a plurality of V-shaped light guide structures corresponding to the first light-out region and the second light-out region, and a V-shaped groove is formed between two adjacent V-shaped light guide structures;
the backlight module further comprises:
a second light source disposed corresponding to the short side of the light-out surface, wherein the second light source has a second light-out surface, which faces a direction parallel to an extension direction of a long axial of the V-shaped light guide structures.

11. The backlight module according to claim 9, wherein the light guide plate has a light-entering lateral surface and a lateral surface opposite to the light-entering lateral surface, the light-out surface has a long side and a short side adjacent thereto, the first light source is disposed corresponding to the short side of the light-out surface, the first light-out surface of the first light source faces the light-entering lateral surface, and the light guide plate comprises:
a plurality of V-shaped light guide structure, wherein a V-shaped groove is formed between two adjacent V-shaped light guide structures;
the backlight module further comprises:
a third light source having a third light-out surface, which faces the opposite lateral surface.

12. The backlight module according to claim 9, wherein the light guide plate comprises:
a plurality of V-shaped light guide structure, wherein a wider V-shaped groove is formed between two adjacent V-shaped light guide structures, and a narrower V-shaped groove is formed between another two adjacent V-shaped light guide structures, the wider V-shaped groove is close to the second light-out region, and the width of the wider V-shaped groove is larger than the width of the narrower V-shaped groove.

13. A backlight module, comprising:
a light guide plate having a light-out surface and a light-entering lateral surface, wherein the light-out surface defines a first light-out region and a second light-out region adjacent to the first light-out region, the light guide plate comprises a first refraction surface, which corresponds to the first light-out region;
a light source disposed corresponding to the light-entering lateral surface, wherein the light source has a first light-out surface, which faces a direction parallel to an extension direction of the first refraction surface;
wherein, when the light source emits a light, the light emitted by the light source emits along a first direction passing through the first refraction surface and then proceeds along a second direction, the first direction is directed towards the second light-out region, and the second direction is directed towards the first light-out region.

14. The backlight module according to claim 13, wherein the first refraction surface projects from the light-out surface.

15. The backlight module according to claim 13, wherein the light guide plate comprises:
a second refraction surface corresponding to the first light-out region, wherein the first light-out surface faces a direction parallel to an extension direction of the second refraction surface;
wherein, when the light source emits a light, the light emitted by the light source emits along a third direction passing through the second refraction surface and then proceeds along a fourth direction, the third direction is directed away from the second light-out region, and the fourth direction is directed towards the first light-out region.

16. The backlight module according to claim 15, wherein the second refraction surface projects from the light-out surface.

17. The backlight module according to claim 13, wherein the first light-out region and the second light-out region both are a strip-shaped light-out region, and the first light-out region is substantially parallel to the second light-out region.

18. The backlight module according to claim 13, wherein the light-out surface has a long side and a short side adjacent thereto, the light guide plate has a light-entering lateral surface, the light source is disposed corresponding to the short side of the light-out surface, and the first light-out surface face the light-entering lateral surface.

19. The backlight module according to claim 15, wherein the light guide plate further has a bottom surface opposite to the light-out surface, the first refraction surface projects from on one of the bottom surface and the light-out surface.

20. The backlight module according to claim 15, wherein the light guide plate further has a bottom surface opposite to the light-out surface, the first refraction surface projects from one of the light-out surface and the bottom surface, and the light guide plate further comprises:
a light expansion structure formed on the other one of the light-out surface and the bottom surface.
